(19) United States
(12) Patent Application Publication
(10) Pub. No.: US 2010/0055359 A1
(43) Pub. Date: Mar. 4, 2010

(54) LAMINATING FILM FOR COATING A METAL SUBSTRATE WHICH CAN BE COLD-FORMED

(75) Inventors: Jurgen Schmidt, Roth (DE); Jurgen Scheuer, Treuchtlingen (DE)

Correspondence Address: HOFFMANN & BARON, LLP, 6900 JERICHO TURNPIKE, SYOSSET, NY, 11791, US

(73) Assignee: LEONHARD KURZ Stiftung & Co. KG, Furth (DE)

(21) Appl. No.: 12/312,707

(22) PCT Filed: Nov. 22, 2007
(86) PCT No.: PCT/EP2007/010104

§ 371 Date: Jul. 8, 2009

(30) Foreign Application Priority Data
Nov. 25, 2006 (DE) 10 2006 055 740.9

(51) Int. Cl. B44F 1/00; B32B 7/02; B32B 38/00

(52) U.S. Cl. 428/29; 428/212; 156/221

(57) ABSTRACT

The invention concerns a laminating film which includes a plurality of layers, for at least partially coating a cold-shapeable metal substrate, and a process for the production of such a metal substrate. The laminating film has a transparent carrier film, at least one transparent lacquer layer containing a diffractive relief structure, a reflection layer and an adhesive layer, wherein the transparent carrier film is formed from PET, wherein the carrier film is of a film thickness in the region of 19 to 75 μm, wherein the carrier film has a modulus of elasticity in the region of 3500 to 5000 N/mm² at least in one direction and wherein the at least one transparent lacquer layer has a modulus of elasticity which differs from the modulus of elasticity of the carrier film by a maximum of 10%, in particular by less than 5%.

The invention concerns a laminating film which includes a plurality of layers for at least partially coating a cold-shapeable metal substrate, and a process for the production of a three-dimensional metal article.

Films and methods of that kind are known from DE 196 10 028 A1. In that case films with a three-layer film structure are used for permanently coating substrates such as metal sheets or plates, wherein the composite assembly formed is subject to subsequent processing in a bending, stamping, edge-grinding, flanging or deep-drawing process. The film has an outer layer of linear polyester such as polyethylene terephthalate or polybutylene terephthalate or of polymethylmethacrylate, as well as a contact layer which adjoins the substrate and which is formed from or contains polypropylene. An adhesive layer is disposed between the outer layer and the contact layer. The film is applied to a cleaned surface of the substrate by means of a primer and/or a bonding agent.

Having regard to the optical appearance of packagings and safeguarding same from unauthorised imitation, demands which are becoming more and more strict are being made in recent years, because of increasing product piracy. Thus a product packaging which is designed to be easily remembered only by means of graphics and/or colour can often no longer give the impression that this is a particularly high-value product. In addition imitation of product packaging of that kind is easily possible.

In the meantime therefore, optically variable safeguarding and/or decoration elements are being applied to packaging materials consisting of paper and/or plastic material. Those elements can optically be of a particularly attractive nature and afford substantially better protection from imitation. Optically variable safeguarding and/or decoration elements give the person viewing them, an optically variable effect or a differing optical appearance. In general, an optical appearance which changes depending on the respective angle of view is referred to as an optically variable effect, in which respect different information contents, images and/or colour changes can become visible.

However, it was hitherto not possible for metal substrates which are cold-worked to afford three-dimensional metal articles to be provided with safeguarding and decoration elements of that kind. After the application of a conventional laminating film containing optically variable safeguarding and/or decoration elements, a pronounced sensitivity to tearing of the laminating film was observed when the metal substrate was subjected to the cold working operation, and that interferes with the optically variable effect and thus also adversely influences the optical appearance of the decorated metal article.

Therefore an object of the present invention is to provide a laminating film for coating cold-shapeable metal substrates, which produces an optically variable effect after shaping of the metal substrate. The invention further seeks to provide a suitable process for the production of three-dimensional metal articles which are decorated with a laminating film of that kind.

The object is attained for the laminating film which includes a plurality of layers and which is provided for at least partially coating a cold-shapeable metal substrate, insofar as the laminating film has in this sequence a transparent carrier film, a transparent lacquer layer containing a diffractive relief structure, and a reflection layer, wherein the transparent carrier film is formed from a thermoplastic material, wherein the carrier film is of a film thickness in the region of 19 to 75 μm, wherein the carrier film has a modulus of elasticity in the region of 3500 to 5000 N/mm² at least in one direction and wherein the transparent lacquer layer has a modulus of elasticity which differs from the modulus of elasticity of the carrier film by a maximum of 10%, in particular by less than 5%.

Accordingly, the laminating film according to the invention has a special carrier film and a novel lacquer layer which is adapted thereto in terms of its expansion behaviour and containing diffractive relief structures. Tests have surprisingly shown that, upon cold shaping of such a metal substrate-laminating film composite arrangement, cracks no longer occur in the reflection layer of the laminating film, which would adversely affect the optical appearance of the shaped laminating film.

The modulus of elasticity of the carrier film is determined in accordance with ISO 527-1-2. In that case the testing speed is 1%/min at 23° C. and 50% relative humidity. In particular the carrier film has an anisotropic modulus of elasticity.

The term cold shaping is used to denote shaping of the metal substrate below the recrystallisation temperature of the metal from which the metal substrate is formed.

Polyesters, in particular PET, polyolefin and polyamide have been found to be appropriate as materials for forming the carrier layer of thermoplastic material.

It has proven to be desirable if the carrier film is of a film thickness in the region of 23 to 36 μm.

In that respect, the carrier film preferably has in a longitudinal direction an elongation at tearing, in relation to its starting length, in the region of 170 to 230%, in particular about 200%, and, perpendicularly to the longitudinal direction, an elongation at tearing in relation to its starting length in the region of 80 to 150%, in particular about 115%.

The elongation at tearing of the carrier film is determined in accordance with ISO 527-1-2. In that case the testing speed is 1%/min at 23° C. and 50% relative humidity.

It has proven desirable if the diffractive relief structure forms a hologram, in particular a 3D/2D hologram or a dot matrix hologram or a Kinegram®.

A diffractive relief structure is preferably embossed into the transparent lacquer layer by means of a suitably structured embossing roller or an embossing punch. In that case, preferably thermoplastic or UV-hardening lacquer layers are used. A diffractive relief structure can however also be formed in the transparent lacquer layer by way of a photolithographic process.

In that respect, production of the laminating film according to the invention is preferably effected in a continuous process in which the carrier film is transported roll-to-roll. In that procedure the transparent lacquer layer is applied to the carrier film and provided with diffractive relief structures, the reflection layer is applied, usually by vapour deposition or sputtering, and finally an adhesive layer is optionally applied.

It is preferred if the adhesive layer is formed with an application amount of adhesive in the region of 5 to 20 g/m², in particular in the region of 7 to 9 g/m². Such an adhesive layer, in particular with a layer thickness in the region of 8 to 10 μm, in combination with the specific, above-described carrier film and the specific lacquer layer, avoids a punctiform, abrupt rise in the shearing forces during the shaping procedure. It is particularly preferred if the adhesive layer is a hot melt adhesive layer, but it is also possible to use cold adhesive layers. The adhesive layer is preferably applied to the metal substrate and the laminating film is fixed therewith on the metal substrate.

The transparent carrier film and/or the lacquer layer can be used coloured.

The laminating layer can also include further layers which serve decorative and/or functional purposes. Thus, a coloured, transparent or opaque printed image can be produced by means of a respective coloured lacquer layer, between the carrier film and the transparent lacquer layer and/or between the transparent lacquer layer and the reflection layer. In that respect it is preferred if coloured lacquer layers used have a similar tearing and elongation characteristic to the transparent lacquer layer and/or are formed in individual pattern surfaces which are not continuously joined together, so that cracks either do not occur in a coloured lacquer layer or at least optically do not appear. In addition transparent bonding agent layers, filling layers, filter layers and the like can be provided as functional layers.

It has been found desirable if the at least one transparent lacquer layer which has the diffractive relief structure is of a layer thickness in the region of 0.5 to 5 μm, in particular in the region of 1 to 2 μm.

In order to increase the adhesion of layers which adjoin the carrier film, it has been found to be desirable if the carrier film is treated by means of a corona discharge at least on one side, in particular on the side on which the lacquer layer is arranged.

It has proven to be advantageous if the reflection layer is of a layer thickness in the region of 5 to 15 nm, in particular in the region of 7 to 9 nm.

In particular it has proven desirable if the reflection layer is formed from metal or a metal alloy. Metallic reflection layers are particularly ductile and thus readily stretchable so that no optical impairment of the appearance of the laminating film occurs after an operation of shaping the metal substrate. Reflection layers consisting of aluminum, chromium, silver, copper, gold and so forth are particularly suitable. Metallic reflection layers impart a particularly high level of brilliancy to the diffractive relief structure and particularly well reproduce the optically variable effects.

Furthermore it has been found to be desirable if the reflection layer is formed from a high-refraction dielectric material (HRI material), such as for example TiO₂, ZnS or ZrO₂. Those materials are usually transparent so that the adhesive layer arranged therebeneath or, if the latter is transparent, the metal substrate, becomes visible. In the case of a dielectric reflection layer, coloured adhesive layers have also proven worthwhile.

In that respect the reflection layer can be formed on the transparent lacquer layer generally over the full surface area involved or only partially. In particular it has proven to be desirable for the reflection layer to be designed in the form of a motif, an image, alphanumeric characters, symbols and/or a raster pattern, in particular in the form of a dot or line raster pattern or a grey scale raster image. By way of example a configuration in line form of a dielectric reflection layer, wherein the lines are oriented substantially perpendicularly to the direction of stretch of the laminating film in the shaping operation, can be advantageous.

An overall thickness of the laminating film without an adhesive layer is preferably in the region of 20 to 30 μm.

The object of the invention is further attained by a process for the production of a three-dimensional metal article comprising the following steps:

providing a composite arrangement comprising a laminating film according to the invention and a metal substrate;

fixing the laminating film on the metal substrate by means of an adhesive layer; and

cold shaping the composite arrangement consisting of the laminating film and the metal substrate to form the three-dimensional metal article in such a way that on an outer surface of the metal article, the laminating film forms a decoration for the metal article.

The process makes it possible to form three-dimensional metal articles which have a decorated surface which is decorated by the laminating film. An optically variable effect is manifested in regions in which the person viewing the article can have a view on to the diffractive relief structure.

It has been found to be desirable if the composite arrangement consisting of the metal substrate and the laminating film is deep-drawn, stamped or pressed.

The use of aluminum sheet, tinplate or steel sheet as the metal substrate has proven desirable. Flat metal substrates of a layer thickness in the region of 0.2 to 5 mm are particularly preferred.

The metal substrate can be covered with the laminating film on at least one side over the full surface area involved. The metal substrate however can also be covered with the laminating film on at least one side, only in region-wise manner, in particular in pattern form. In that case, in particular regions of the metal substrate which experience particularly severe deformation in the shaping operation or regions of the metal substrate which, after the shaping operation, involve a severe curvature, in particular in the region of >90°, are cut out.

The use of a composite arrangement comprising a flat metal substrate with a laminating film according to the invention, for the production of a three-dimensional metal article which is decorated with the laminating film, is ideal.

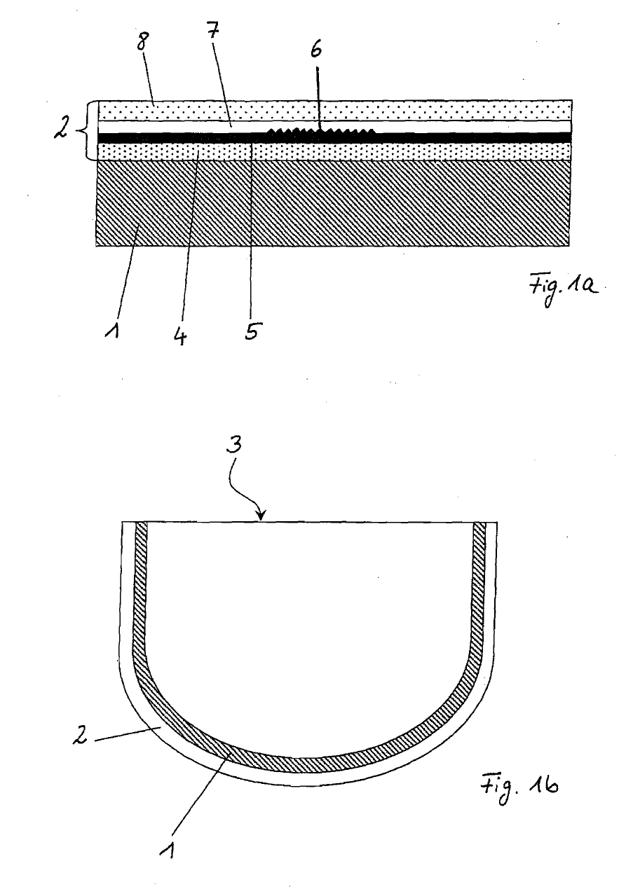

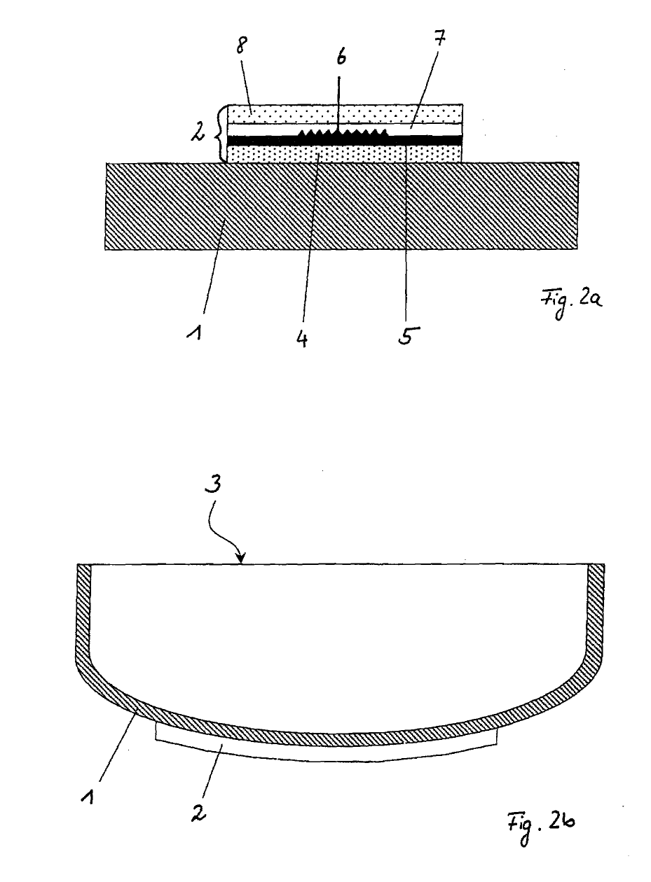

FIGS. 1a to 2b are intended to describe by way of example a laminating film according to the invention and a process according to the invention. In the Figures:

FIG. 1a shows a cross-section through a composite arrangement comprising a metal substrate and a laminating film,

FIG. 1b shows a cross-section through a metal article formed by shaping of the composite arrangement shown in FIG. 1a,

FIG. 2a shows a cross-section through a further composite arrangement comprising a metal substrate and a laminating film, and

FIG. 2b shows a cross-section through a metal article formed by shaping of the composite arrangement shown in FIG. 2a.

FIG. 1a shows a cross-section through a composite arrangement comprising a flat metal substrate 1 and a laminating film 2 according to the invention. Here, the laminating film 2 includes an adhesive layer 4, a reflection layer 5, a transparent lacquer layer 7 including a diffractive relief structure 6, and a transparent carrier film 8. A bonding agent layer (not shown here) can be provided between the lacquer layer 7 and the carrier film. The adhesive layer 4 is a hot melt adhesive layer which is fixedly joined to or glued to a surface of the metal substrate 1. In that situation the laminating film 2 completely covers one side of the metal substrate 1. The reflection layer 5 is formed from aluminum and is vapour-deposited on the transparent lacquer layer 7, in a layer thickness of 8 nm. The transparent lacquer layer 7 is applied to the carrier layer in a layer thickness of 1.5 μm and the diffractive relief structure 6 is embossed into the transparent lacquer layer 7.

The transparent lacquer layer 7 here is of the following composition:

| Component | Parts by weight |
|---|---|
| High-molecular PMMA resin | 500 |
| Non-ionic wetting agent | 50 |
| Low-viscosity nitrocellulose | 2000 |
| Methylethylketone | 6600 |
| Toluene | 2000 |
| Cyclohexanone | 4000 |

The carrier film 8 is formed from a stretched polyester film and is of a layer thickness of 23 μm. The metal substrate 1 comprises aluminum.

The composite arrangement shown in FIG. 1a is now cold-shaped to form a metal article, in this case by deep drawing.

FIG. 1b shows a cross-section through a metal article 3 formed from the composite arrangement of FIG. 1a, after the cold shaping operation. The metal substrate 1, including the laminating film 2, was three-dimensionally shaped, in which case a cap-shaped metal article 3 was formed. The laminating film 2 was stretched together with the metal substrate 1 and now completely covers the outer surface of the metal article 3 or the cap, in which case the diffractive structure 6 (not shown here) is visible through the carrier film 8 and the transparent lacquer layer 7 and shows an optically variable effect. In this case the optically variable effect can already be manifested in the unshaped laminating film 2 or only after the shaping operation, on the finished metal article 3.

FIG. 2a shows a cross-section through a further composite arrangement comprising a metal substrate 1 and a laminating film 2, the structure of the composite arrangement corresponding to that described with reference to FIG. 1a. However, the laminating film 2 only partially covers one side of the metal substrate 1.

The composite arrangement of FIG. 2a is now cold-shaped to form a metal article, here by deep drawing.

FIG. 2b shows a cross-section through a metal article 3 formed from the composite arrangement of FIG. 2a, after the cold shaping operation. The metal substrate 1, including the laminating film 2, was three-dimensionally shaped, in which case a cap-shaped metal article 3 was formed. The laminating film 2 was stretched together with the metal substrate 1 and now partially covers the outer surface of the metal article 3 or the cap, in which case the diffractive structure 6 (not shown here) is visible through the carrier film 8 and the transparent lacquer layer 7 and shows an optically variable effect. In this case the optically variable effect can already be manifested in the unshaped laminating film 2 or only after the shaping operation, on the finished metal article 3.

It will be appreciated that it is equally possible to use laminating films with a different layer structure. Thus, the reflection layer can be provided only region-wise on the transparent lacquer layer, and there can be further transparent lacquer layers containing diffractive structures, 5 further reflection layers, further lacquer layers which are optionally coloured, bonding agent layers or adhesive layers.

1. A laminating film which includes a plurality of layers, for at least partially coating a metal substrate, which is to be cold-shaped after the coating operation wherein
the laminating film has in this sequence a transparent carrier film, at least one transparent lacquer layer containing a diffractive relief structure and a reflection layer, wherein the transparent carrier film is formed from a thermoplastic material, wherein the carrier film is of a film thickness in the region of 19 to 75 μm, wherein the carrier film has a modulus of elasticity in the region of 3500 to 5000 N/mm² at least in one direction and wherein the at least one transparent lacquer layer has a modulus of elasticity which differs from the modulus of elasticity of the carrier film by a maximum of 5%.

2. A laminating film as set forth in claim 1, wherein the carrier film in a longitudinal direction has an elongation at tearing in the region of 170 to 230% and perpendicularly to the longitudinal direction an elongation at tearing in the region of 80 to 150%.

3. A laminating film as set forth in claim 1, wherein the carrier film is formed from polyester, polyolefin or polyamide.

4. A laminating film as set forth in claim 1, wherein the diffractive structure forms a 3D/2D hologram or a dot matrix hologram.

5. A laminating film as set forth in claim 1, wherein the carrier film is of a film thickness in the region of 23 to 36 μm.

6. A laminating film as set forth in claim 1, wherein the transparent lacquer layer is of a layer thickness in the region of 1 to 2 μm.

7. A laminating film as set forth in claim 1, wherein the carrier film is treated by means of a corona discharge at least on the side on which the transparent lacquer layer is arranged.

8. A laminating film as set forth in claim 1, wherein the reflection layer is of a layer thickness in the region of of 7 to 9 nm.

9. A laminating film as set forth in claim 1, wherein the reflection layer is formed from aluminum, chromium, silver, copper or gold.

10. A laminating film as set forth in claim 1, wherein the reflection layer is formed from TiO₂; ZnS or ZrO₂.

11. A laminating film as set forth in claim 1, wherein the laminating film has an adhesive layer arranged beneath the reflection layer and wherein the adhesive layer is formed with an applied amount of adhesive in the region of 7 to 9 g/m².

12. A laminating film as set forth in claim 1, wherein the adhesive layer is a hot melt adhesive layer.

13. A laminating film as set forth in claim 1, wherein the laminating film without an adhesive layer is of a thickness in the region of 20 to 30 μm.

14. A process for the production of a three-dimensional metal article comprising the following steps:
providing a composite arrangement comprising a laminating film as set forth in claim 1 and a metal substrate;
fixing the laminating film on the metal substrate by means of an adhesive layer; and
cold shaping the composite arrangement consisting of the laminating film and the metal substrate to form the three-dimensional metal article in such a way that on an outer surface of the metal article (3), the laminating film forms a decoration for the metal article.

15. A process as set forth in claim 14, wherein the composite arrangement is deep-drawn, stamped or pressed.

16. A process as set forth in claim 14, wherein a flat metal substrate formed from aluminum sheet, tinplate or steel sheet is connected to the laminating film.

17. A process as set forth in claim 14, wherein the metal substrate which is of a layer thickness in the region of 0.2 to 5 mm is connected to the laminating film.

18. A process as set forth in claim 14, wherein the metal substrate is covered with the laminating film on at least one side over the full surface area.

19. A process as set forth in claim 14, wherein the metal substrate is covered with the laminating film on at least one side only in in pattern form.

20. A three-dimensional metal article including a three-dimensional, shaped metal substrate wherein a laminating film as set forth in claim 1 is fixed on a surface of the metal substrate by means of an adhesive layer.
